(19) United States
(12) Patent Application Publication
(10) Pub. No.: US 2018/0330234 A1
(43) Pub. Date: Nov. 15, 2018

(54) PARTIAL WEIGHTS SHARING CONVOLUTIONAL NEURAL NETWORKS

(71) Applicant: Hussein Al-barazanchi, Placentia, CA (US)

(72) Inventor: Hussein Al-barazanchi, Placentia, CA (US)

(21) Appl. No.: 15/593,250

(22) Filed: May 11, 2017

(51) Int. Cl. G06N 3/08; G06N 3/04; G06K 9/46

(52) U.S. Cl. CPC G06N 3/08; G10L 15/16; G06K 9/4628; G06N 3/04

(57) ABSTRACT

The present invention introduces a new type of Convolutional Neural Networks (CNN), which I named as Partial Weights Sharing Convolutional Neural Networks (PWS-CNN). All CNN based systems use a stack of small filters called Convolutional Kernels in each convolutional layer of the system. These Kernels are small in size but they use a lot of memory for their output values. These kernels are isolated between them and they do not share their weights. In my invention, I am introducing a new way to allow these kernels to share their weights partially. With the use of my invention, the amount of memory needed to run PWS-CNN based system will be drastically reduced compared with the current CNN based system. Also, the new system will be significantly faster.

### BACKGROUND

### Field of the Invention

The present invention relates to Convolutional Neural Networks (CNN). The heart of the invention lies in re-engineering the working mechanism of CNN's kernels (filters).

### Description of the Related Art

CNN based systems are considered as the best systems in image recognition, voice recognition, and etc. FIG. 1 shows a high level abstraction of CNN based system. CNN systems typically consist from Input, Convolutional Layer (can be any number of layers), Hidden Layer (Fully Connected Neural Networks) (can be any number of layers) (optional), and an Output Layer. Each Convolutional Layer consists from kernels stack, activation function, and subsampling operation (optional).

Each Convolutional Layer works by allowing each kernel from its kernels stack to scan the input's elements. The kernel will perform its operations on those elements. This will result in having multiple output values for each kernel. There are two important factors in the scanning operation. The first factor is the kernel size (also called reception field) and the second factor is the stride value (the number of elements in the input that will be skipped when sliding the kernel during the scan operation).

To demonstrate the working mechanism of convolutional kernel, I am using a very simple example. I am assuming that the input is a one dimensional array of 5 elements so the kernels should also be one dimensional. Also, I am assuming that the reception field is 3 and the stride value is 1. In this case, the kernel is 3 elements of weights numbered W1, W2, and W3 as shown in FIGS. 3, 4, and 5. FIGS. 3, 4, and 5 illustrate the sequence of operations performed by one kernel from the kernels stack of Convolutional Layer.

In FIG. 3, those weights are multiplied by their corresponding elements in the Input and the outputs from these multiplications is stored in Result-1. The values in Result-1 are then summed to give Result-2. After that, a Bias value is added to Result-2 to give Result-3. Result-3 is then used as an input to an Activation Function where I am using ReLU function for illustration purposes. The output from ReLU is named the Output because it is the last operation performed by the kernel. An optional subsampling operation may apply to the Output but it is not related to the core of discussion here.

The same sequence of operations will be performed again on the input using the same kernel by sliding the kernel's weights to other elements in the input by the specified value of stride. Because I am using a stride of 1, you can see in FIG. 4 that the Kernel-1 is shifted to the second value in the input. The operations will continue until Kernel-1 scans all the elements in the input.

The operations described above is just for one kernel from the kernels stack of CNN. All kernels in the stack will perform the same sequence of operations. Usually the Convolutional stacks consist from 64, 128, 256, or 512 kernels. So you can imagine how much memory will be needed to store the Output values from these kernels. This is the basic mechanism used by all different variations of CNN.

### SUMMARY

The present invention will reduce the amount of memory required to train CNN based systems. Also, the present invention will reduce the amount of memory required to deploy CNN based systems. The present invention will accelerate CNN based systems during the training and deploying phases

Instead of having isolated kernels in the kernels stack in each Convolutional Layer, the present invention assigns a specific weight to each input value. Which will allow different kernels to share these weights partially. This will result in reducing the size of Output values required for kernels stack drastically.

### BRIEF DESCRIPTION OF THE DRAWINGS

FIG. 1 gives a high level abstraction of traditional CNN based system.

FIG. 2 gives a high level abstraction of my invention which is titled Partial Weights Sharing Convolutional Neural Networks (PWS-CNN).

FIGS. 3, 4, and 5 describe the core operations performed by traditional CNN on a one dimensional input.

FIGS. 6, 7, and 8 describe the core operations performed by PWS-CNN on a one dimensional input.

### DETAILED DESCRIPTION

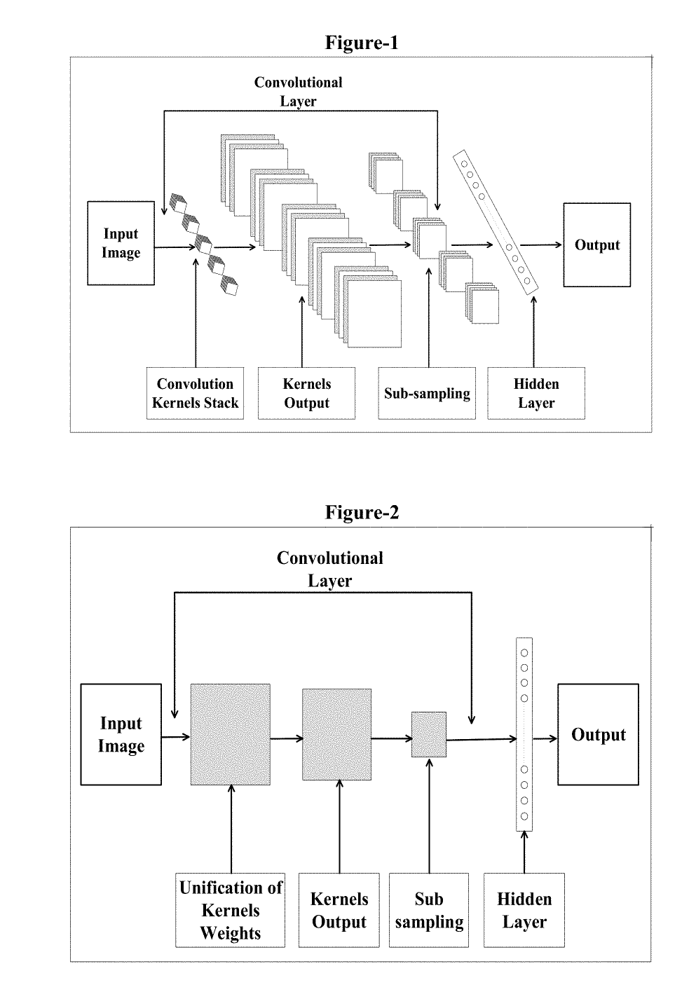

FIG. 2 shows the general architecture of my invention and it's difference from traditional CNN that is shown in FIG. 1. Both figures show how the system works in case of having an image as an input. The core of my invention relies on assigning specific weights to each input value and forcing the kernels to share these weights with other kernels partially. Instead of having separate kernels that generate a lot of intermediate values, I am combining the kernels together in the element pointed to as the “Unification of Kernels Weights” as shown in FIG. 2.

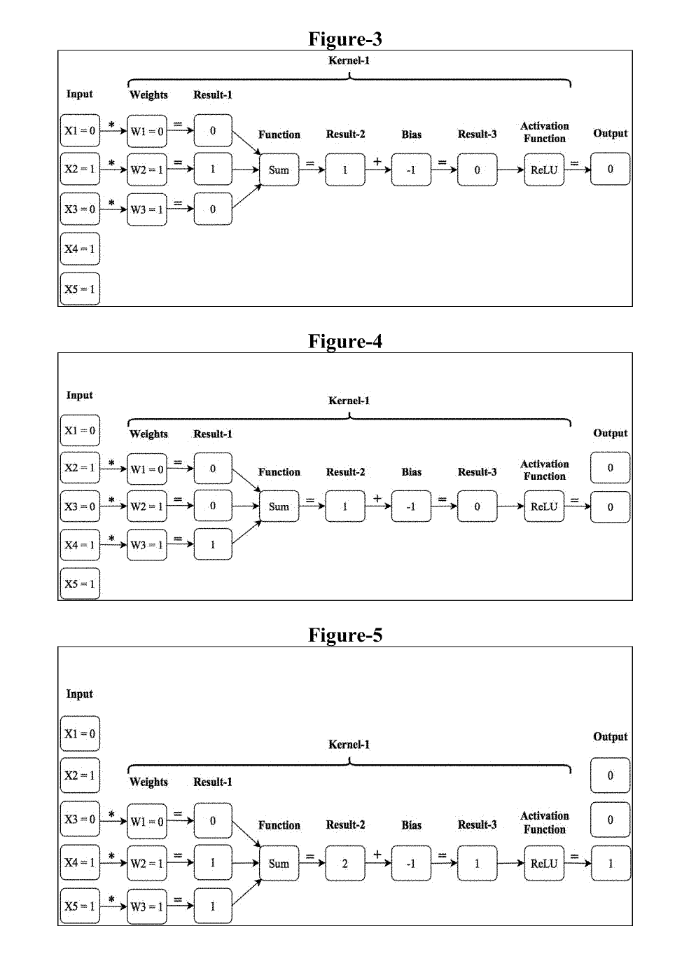

For the sake of simplicity, I am using the same example as used in describing traditional CNN which is one dimensional array of size 5. The kernel size (reception field) is the same as before which is 3 with a stride value of 1. All values used in FIGS. 3, 4, 5, 6, 7, and 8 are just for demonstration purpose.

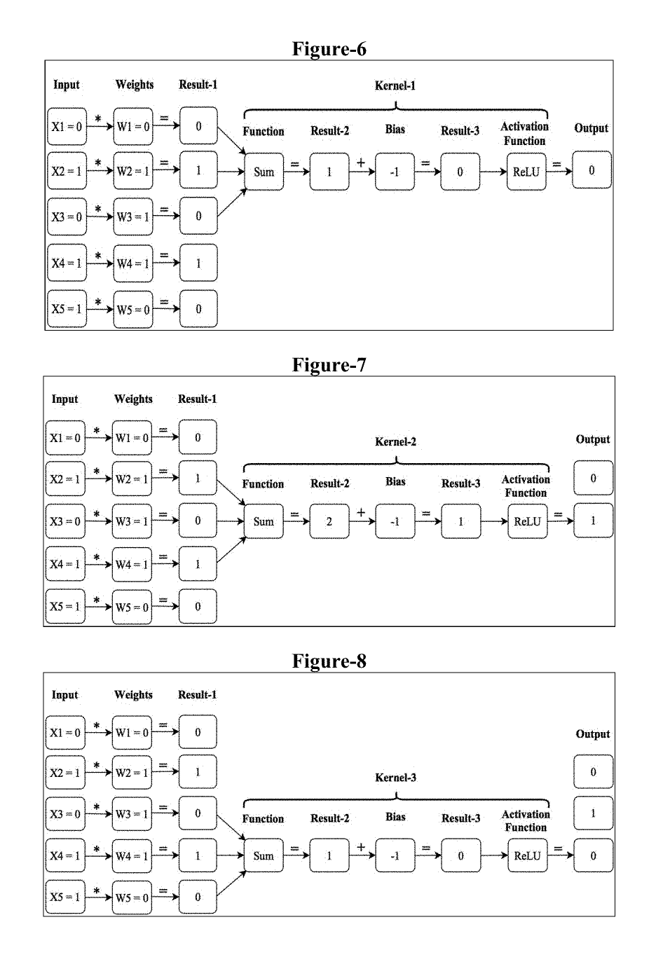

The present invention begins working by initializing weights values of size that is equal to the input size as shown in FIG. 6. Now, each input element has a specific weight value corresponding to it. Each weight value is multiplied by the corresponding input element to give Result-1. The size of Result-1 is equal to the Input size.

As we are using a kernel size (reception field) of 3, the first 3 elements in result-1 are summed to give Result-2. Result-2 value is added with value of the bias to give Result-3. Then the activation function is applied to Result-3 to give the output. The output value in this case is for Kernel-1. FIG. 6 shows the sequence of operations.

The kernel stride we are using is 1. So Kernel-2 will work starting from the second element in Result-1 as shown in FIG. 7. Kernel-2 will follow the same sequence of operations used in Kernel-1. Now, it is clear that Kernel-2 is sharing two weights with Kernel-1 which are W2 and W3 as shown in FIG. 7.

Kernel-3 starts working from the third element in Result-1 as shown in FIG. 8. Kernel-3 follows the same sequence of operations performed by Kernel-1 and Kernel-2. It is clear now that Kernel-3 shares two weights with Kernel-2 which are W3 and W4. While it is sharing only one weight with Kernel-1 which is W3.

The difference between my invention and traditional CNN is forcing kernels to share their weights in partial way.

1. The present invention will reduce the memory usage of Convolutional Neural Networks during the training phase of the system and during the deployment phase of the system.
The present invention will speed up Convolutional Neural Networks based system during the training phase of the system and during the deployment phase of the system.
